(19) United States
(12) Patent Application Publication
(10) Pub. No.: US 2006/0045530 A1
(43) Pub. Date: Mar. 2, 2006

(54) Compact optical transceiver module

(76) Inventors: Sin Heng Lim, Singapore (SG); Wee Sin Tan, Singapore (SG); Peng Yam Ng, Singapore (SG); Suresh Basoor, Singapor (SG); Kuldeep Kumar Saxena, Singapore (SG)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/930,578

(22) Filed: Aug. 31, 2004

(51) Int. Cl. H04B 10/00

(52) U.S. Cl. 398/135

(57) ABSTRACT

An optical transceiver includes a substrate having first and second sides. A light emitter mounted to the first side. A light receiver is mounted to the first side and comprises a dielectric totally internally reflecting concentrator directing light to a photodetector. Amplification circuits are mounted to the second side and are electrically connected to the light emitter and the light receiver through the substrate. The light emitter and the light receiver are housed in separate molded housings. A DTIRC is used to provide a good link distance and a wide field of view.

### FIELD OF THE INVENTION

The invention relates to the field of optoelectronics. More particularly, the present invention relates to the field of optical communications.

### BACKGROUND OF THE INVENTION

Infrared optical transceivers need to provide good link distance and wide field of view (“FOV”) between a variety of communicating devices such as laptop computers, personal digital assistants (“PDA”), printers and mobile phones. As these devices become smaller, it is also very important for the infrared optical transceivers to become more compact. Additionally, low power consumption is very important for these portable devices.

Optical transceivers often use hemispherical lenses to receive and focus incoming light. One prior-art solution for increasing the link distance between communicating devices is to increase the lens size of the hemispherical receiver lens. However, this solution increases the size of the transceiver package.

Optical transceivers often generate light using light emitting diodes (“LED”). Another prior-art solution for increasing the link distance is to increase the electric current driving the LED of the emitter to produce a more intense and further traveling light beam. However, this solution leads to high power consumption and shorter battery life.

U.S. Pat. No. 5,506,445 to Rosenberg illustrates an infrared optical transceiver module. Both an LED (104), for transmitting an infrared (“IR”) signal, and a photodiode (106), for detecting an incoming IR signal, are connected to a common leadframe (103). Also attached to the leadframe is an integrated circuit (101) (“IC”) which drives the LED and amplifies the photo-electric current of the photodiode. A transceiver body (105) is molded around the leadframe/LED/photodiode/IC combination. The transceiver body includes first and second hemispherical concentrator lenses (121, 123) molded over the LED and photodiode through which the IR signals are transmitted and received. The complete transceiver module is mounted on a PCB.

One result of Rosenberg's design is that the emitter, receiver and IC are all on the same side of the substrate, resulting in a relatively large footprint of the transceiver module on the PCB. Moreover, Rosenberg does not address the problems of providing a compact design, long link distance between devices, wide field of view between devices, and low power consumption.

Also, Rosenberg's use of a hemispherical concentrator lens for collecting the light and sending it to the receiver is not optimal. A receiver having a lens with improved optical gain and a wider field of view would be desirable because it would result in a long link distance between devices and wide field of view between devices. However, such a lens would be more complicated to manufacture and would not be easy to combine in a single mold with the leadframe/LED/photodiode/IC combination as done by Rosenberg with the combination of the hemispherical lens with the leadframe/LED/photodiode/IC in a single mold.

Also, Rosenberg does not address a design for improved manufacturing economy. It is difficult to provide a stable solder connection between the leadframe tabs (124) and the main PCB because the leadframe tabs are long and must be kept coplanar with each other during soldering. It is also expensive, inconvenient and slow to trim the leads in the complex arrangements of FIGS. 4-6 of Rosenberg. Also, a large amount of epoxy forms the transceiver body for housing the transceiver. This large amount of epoxy can result in reliability problems during thermal stressing.

It would be desirable to provide a compact optical transceiver module having a long link distance, wide field of view and low power consumption, while at the same time allowing an economical manufacturing process.

### SUMMARY OF THE INVENTION

The optical transceiver of the present invention provides a compact optical transceiver module having a long link distance, wide field of view and low power consumption, while at the same time allowing an economical manufacturing process.

The optical transceiver includes a substrate having first and second sides. A light emitter mounted to the first side. A light receiver is mounted to the first side and comprises a dielectric totally internally reflecting concentrator directing light to a photodetector. Amplification circuits are mounted to the second side and are electrically connected to the light emitter and the light receiver through the substrate. The light emitter and the light receiver are housed in separate molded housings.

The method of manufacturing the optical transceiver comprising the steps of: mounting amplification circuits to a second side of a substrate having at least one electrical terminal passing through the substrate; and mounting a light emitter and a light receiver to a first side of the substrate using an SMT process so that they are electrically connected to the amplification circuits through at least one of the electrical terminals. In this method the light receiver comprises a dielectric totally internally reflecting concentrator directing light to a photodetector.

The light receiver is manufactured by mounting a photodetector to a leadframe; electrically connecting the photodetector to the leadframe; and enclosing the leadframe within the light receiver;

The light emitter is manufactured by mounting an LED to a leadframe; electrically connecting the LED through the leadframe; and enclosing the leadframe within the light receiver.

### BRIEF DESCRIPTION OF THE DRAWINGS

FIG. 1 shows an optical transceiver of the present invention.

FIG. 2 shows an embodiment of the optical transceiver of FIG. 1 using a flip-chip IC.

FIG. 3 is a flowchart illustrating the method of manufacturing the optical transceiver of FIGS. 1 and 2.

FIG. 4 is a flowchart illustrating the method of manufacturing the emitter of FIGS. 1 and 2.

FIG. 5 is a flowchart illustrating the method of manufacturing the receiver of FIGS. 1 and 2.

### DETAILED DESCRIPTION

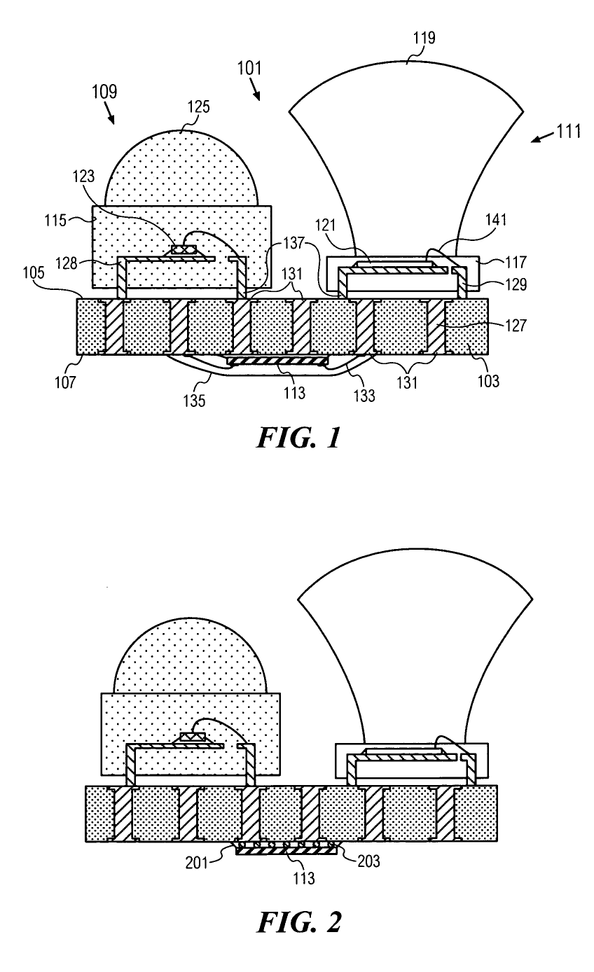

FIG. 1 shows an optical transceiver 101. A substrate 103 has a first side 105 and a second side 107. A light emitter 109 and a light receiver 111 are mounted to the first side 105. The light emitter 109 and light receiver 111 can be mounted to the first side 105 by means of leadframes 128, 129, respectively. Amplification circuits 113 are mounted to the second side 107 and are electrically connected to the light emitter 109 and the light receiver 111 through electrical terminals 127 passing through the substrate 103. The amplification circuits 113 drive the light emitter 109 to generate an output signal and also amplify the input signal received by the light receiver 111.

By mounting the light emitter 109 and light receiver 111 on the opposite side of the substrate 103 relative to the amplification circuits 113, the optical transceiver 101 has a smaller footprint than the transceiver of Rosenberg where the emitter, receiver and IC are all mounted on the same side of the substrate. Thus, in the present invention, a substrate having a smaller surface area and reduced length along the direction of the light emitter 109, light receiver 111 and amplification circuits 113 can be used.

The light emitter 109 mounted on the leadframe 128, and the light receiver 111 mounted on the leadframe 129 are housed in separate molded housings 115 and 117, respectively. The molded housing 117 can include a dielectric totally internally reflecting concentrator lens 119 for directing light to a photodetector 121 of the light receiver 111. The molded housing 115 can include a hemispherical concentrator lens 125 for directing light from an LED 123 of the light emitter 109. The separate molded housings 115 and 117 allow the use of mass-produced light emitters and receivers 109, 111 and the use of surface mount technology (“SMT”) processes for mounting the light emitter and receiver 109, 111 to the substrate 103. The separate molded housings 115 and 117 also provide an additional advantage over the unitary transceiver body (105) of the Rosenberg reference. The present invention, by having separate molding housings, requires less epoxy and no significant stress is induced across the substrate, resulting in better reliability during thermal stressing.

In the present description of the invention, the terms “optical” and “light” are used to describe the portion of the electromagnetic spectrum in or near the visible region. More particularly, this part of the electromagnetic spectrum is defined to include visible, infrared and ultraviolet radiation in the range from approximately 4 nanometers to 1000 nanometers.

Thus, by describing the invention as an “optical transceiver” what is meant is that it is not designed for the detection of electromagnetic radiation outside this range from approximately 4 nanometers to 1000 nanometers. Rather, the optical transceiver of the present invention has embodiments detecting electromagnetic radiation covering the entire approximately 4 nanometers to 1000 nanometers light spectrum and also has embodiments covering various sub-ranges of the light spectrum such as the infrared, ultraviolet or visible ranges.

In the present description of the invention, the term “infrared” is used to describe the range of invisible radiation wavelengths from about 750 nanometers to 1000 nanometers. The term “ultraviolet” is used to describe the range of invisible radiation wavelengths from about 4 nanometers to about 380 nanometers. The term “visible light” is used to describe electromagnetic radiation that has a wavelength in the range from about 400 nanometers (violet) to about 770 (red) nanometers and may be perceived by the normal unaided human eye. An embodiment of the present invention is said to operate within any of these ranges as long as it operates within a sub-range within the broader range.

The invention is now described in more detail with reference to FIGS. 1-3.

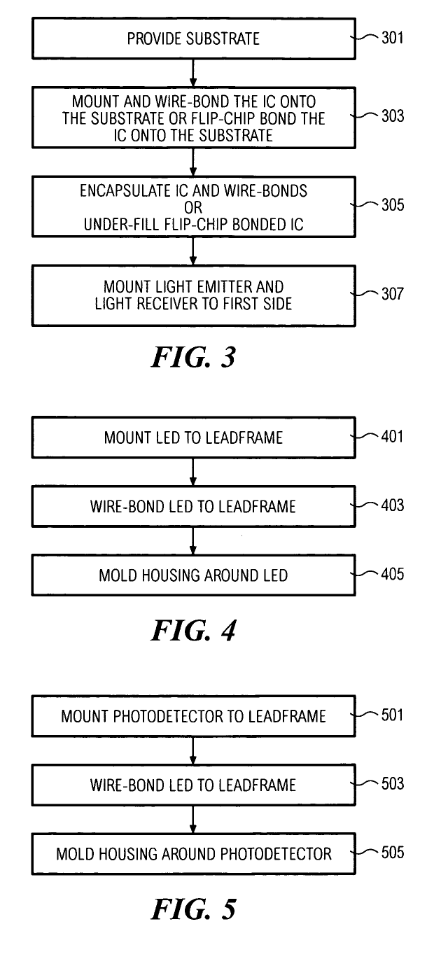

As illustrated at step 301 of FIG. 3, the substrate 103 having the first side 105 and the second side 107 is provided. The substrate 103 can be a PCB, a planar organic substrate such as an FR4/5 printed circuit board or can be a ceramic substrate, for example. Wire-bonding pads 131 are deposited on the first and second sides 105, 107 of the substrate 103 and these pads 131 are electrically connected by the electrical terminals 127 passing through the substrate 103.

At step 303 the amplification circuits 113 are mounted to the second side 107 of the substrate 103. The amplification circuits 113 can, more specifically, be implemented by one or more integrated circuits (“IC”). The amplification circuits 113 are attached to the substrate using silver epoxy and are then wire-bonded with wirebonds 133 to the wire-bonding pads 131. Next, at step 305 the amplification circuits 113 and wirebonds 133 are encapsulated using glob top encapsulant epoxy 135 to protect against mechanical shock and vibration and to protect against environmental damage such as corrosion.

Alternatively, as illustrated in FIG. 2, the amplification circuits 113 can be implemented by one or more ICs of the flip-chip type. In this embodiment at step 303 the flip-chip is flip-chip bonded to the substrate 103. Then at step 305 under-fill materials 201 are used to protect interconnects 203 between the amplification circuits 113 and the pads 131.

At step 307 the light emitter 109 and the light receiver 111 are mounted to the first side 105 of the substrate using a surface mount technology (“SMT”) such as a pick and place machine and reflow process or using a wave soldering process.

FIG. 4 illustrates the steps for fabricating the emitter 109. At step 401 the LED 123 is mounted to the leadframe 128 using a prior-art die attached process and at step 403 is electrically connected to the leadframe 128 with a wire-bond 139 as is known in the art. At step 405 the molded housing 115 is formed around the LED 123 and leadframe 128 while allowing leadframe tabs 137 to extend from the housing 115. The molded housing 115 can include an integral or separately formed hemispherical concentrator lens 125 for directing light from the LED 123 of the light emitter 109.

FIG. 5 illustrates the steps for fabricating the receiver 111. At step 501 the photodetector 121 is mounted to the leadframe 129 and at step 503 is electrically connected to the leadframe 129 with a wire-bond 141 as is known in the art. The photodetector 121 can be a photodiode or a phototransistor, for example. At step 505 the molded housing 117 is formed around the photodetector 121 and leadframe 129 while allowing leadframe tabs 137 to extend from the housing 117. The molded housing 117 can include an integral or separately formed dielectric totally internally reflecting concentrator lens (“DTIRC”) 119 for directing light to the photodetector 121 of the light receiver 111.

The emitter and receiver housings 115, 117 can be made from epoxy such as MG-18 Hysol or can be made from Hysol OS4210 using a casting process. The use of the separately housed emitter 109 and receiver 111 allows for better mass production when the DTIRC 119 is integral with the receiver 111. It also allows for economical mounting of the emitter 109 and receiver 111 onto the substrate 103 using a surface mount technology (“SMT”) process such as a pick and place machine and reflow process or a wave soldering process. Another advantage is that the leadframe tabs 121 are relatively short and are directly aligned and soldered to the electrical terminals 127 without the need for trimming as in Rosenberg.

The DTIRC 119 can be obtained from the company Optical Antenna Solution. The DTIRC 119 is based on the internal reflection of IR rays on its lateral surface. Advantages of a DTIRC are described in Pavlosoglou et al., “A Security Application of the Warwick Optical Antenna in Wireless Local and Personal Area Networks”.

Compared with the hemispherical concentrator lenses used in the light receivers of the prior art, the DTIRC has improved optical gain and a wider field of view. This helps provide the optical transceiver of the present invention with a compact design, long link distance between devices, wide field of view between devices, and low power consumption compared to the prior art optical transceivers. Additionally, the use of the DTIRC 119 allows for the use of a smaller photodetector 121, resulting in decreased cost, allowing the use of smaller capacitors and improved receiver sensitivity.

Rosenberg combines the leadframe/LED/photodiode/IC along with the first and second hemispherical concentrator lenses (121, 123) in a unitary mold. However, the DTIRC 119 used by the present invention has a more complicated design than the hemispherical concentrator lenses (121, 123) used by Rosenberg. Therefore, it is not practical to mass-produce the DTIRC 119 in a single mold along with the leadframe/LED/photodiode/IC combination. Therefore, in the present invention the light emitter 109 mounted on the leadframe 128, and the light receiver 111 mounted on the leadframe 129 are housed in the separate molded housings 115 and 117, respectively. It is the molded housing 117 which includes the DTIRC 119. In this way the molded housing 117 with the integral DTIRC 119 can easily be mass-produced.

The amplification circuits 113 mounted to the second side 107 of the substrate 103 provide an electric current for driving the LED 123 to generate an output signal. The driving current is supplied to the LED 123 through the electrical connection provided by the wirebonds 133 of FIG. 1 (or interconnects 203 in FIG. 2), the pads 131 on the second side 107 of the substrate 103, the electrical terminals 127, the pads on the first side 105 of the substrate 103, the leadframe tabs 137, the leadframe 128, and the wirebond 139.

The amplification circuits 113 also amplify the photo-electric current produced by the photodetector 121 in response to an optical input signal. The photo-electric current passes from the photodetector 121, through the wirebond 141, the leadframe 128, the leadframe tabs 137, the pads 131 on the first side 105 of the substrate 103, the electrical terminals 127, the pads 131 on the second side 107 of the substrate 103 and the wirebonds 133 to the amplification circuits 113.

Connections

In a preferred embodiment the optical transceiver 101 operates in the infrared light range. Thus, the light emitter 109 emits infrared light, the light receiver 111 receives infrared light and the amplification circuits 113 amplify infrared light received by the light receiver 111 and emitted by the light emitter 109.

In the foregoing specification, the invention has been described with reference to specific exemplary embodiments thereof. The specification and drawings are, accordingly, to be regarded in an illustrative sense rather than a restrictive sense.

1. An optical transceiver comprising:
a substrate having first and second sides;
a light emitter mounted to the first side;
a light receiver mounted to the first side; and
amplification circuits mounted to the second side and electrically connected to the light emitter and the light receiver through the substrate.

2. The optical transceiver of claim 1, wherein the light receiver comprises a dielectric totally internally reflecting concentrator directing light to a photodetector.

3. The optical transceiver of claim 1, wherein the light emitter and the light receiver are housed in separate molded housings

4. The optical transceiver of claim 2, wherein the photodetector is a photodiode.

5. The optical transceiver of claim 2, wherein the photodetector is a phototransistor.

6. The optical transceiver of claim 2, wherein the photodetector is mounted to a leadframe enclosed within the light receiver, the leadframe electrically connecting the photodetector to an electrical terminal passing through the substrate, the electrical terminal electrically connecting the amplification circuits to the light emitter and the light receiver.

7. The optical transceiver of claim 1, wherein the light emitter comprises a hemispherical concentrator directing light from an LED.

8. The optical transceiver of claim 1, wherein the light emitter includes an LED.

9. The optical transceiver of claim 8, wherein the LED is mounted to a leadframe enclosed within the light emitter, the leadframe electrically connecting the LED to an electrical terminal passing through the substrate, the electrical terminal electrically connecting the amplification circuits to the light emitter and the light receiver.

10. The optical transceiver of claim 1, wherein the substrate comprises at least one electrical terminal passing through the substrate and electrically connecting the amplification circuits to the light emitter and the light receiver.

11. The optical transceiver of claim 1, wherein the substrate is an organic substrate.

12. The optical transceiver of claim 1, wherein the substrate is a ceramic substrate.

13. The optical transceiver of claim 1, wherein the amplification circuits are fabricated on an integrated circuit.

14. The optical transceiver of claim 11, wherein the integrated circuit is a flip-chip.

15. The optical transceiver of claim 10, wherein the amplification circuits are fabricated on an integrated circuit wire-bonded to the electrical terminal.

16. The optical transceiver of claim 15, further comprising epoxy encapsulating the integrated circuit and wire-bonds.

17. The optical transceiver of claim 1, wherein the light emitter emits infrared light, the light receiver receives infrared light and the amplification circuits amplify infrared light received by the light receiver and emitted by the light emitter.

18. The optical transceiver of claim 1, wherein the light emitter and light receiver are mounted to the first side using a pick and place machine and reflow process.

19. A method of manufacturing an optical transceiver comprising the steps of:
mounting amplification circuits to a second side of a substrate having at least one electrical terminal passing through the substrate; and
mounting a light emitter and a light receiver to a first side of the substrate using an SMT process so that they are electrically connected to the amplification circuits through at least one of the electrical terminals.

20. The method of claim 19, wherein the light receiver comprises a dielectric totally internally reflecting concentrator directing light to a photodetector.

21. The method of claim 20, wherein the photodetector is a photodiode.

22. The method of claim 20, wherein the photodetector is a phototransistor.

23. The method of claim 20, further comprising the steps of:
mounting the photodetector to a leadframe;
enclosing the leadframe within the light receiver;
electrically connecting the photodetector through the leadframe to an electrical terminal passing through the substrate; and
electrically connecting the amplification circuits through the leadframe to the light emitter and the light receiver.

24. The method of claim 19, wherein the light emitter comprises a hemispherical concentrator directing light from an LED.

25. The method of claim 19, wherein the light emitter includes an LED.

26. The method of claim 25, further comprising the steps of:
mounting the LED to a leadframe;
enclosing the leadframe within the light receiver;
electrically connecting the LED through the leadframe to an electrical terminal passing through the substrate; and
electrically connecting the amplification circuits through the leadframe to the light emitter and the light receiver.

27. The method of claim 19, wherein the substrate is an organic substrate.

28. The method of claim 19, wherein the substrate is a ceramic substrate.

29. The method of claim 19, wherein the amplification circuits are fabricated on an integrated circuit.

30. The method of claim 29, wherein the integrated circuit is a flip-chip.

31. The method of claim 29, further comprising the step of wire-bonding the integrated circuit to the electrical terminal.

32. The method of claim 31, further comprising the step of encapsulating the amplification circuits and wire-bonds with epoxy.

33. The method of claim 19, wherein the step of mounting the light emitter and the light receiver to the first side of the substrate further comprises the step of using a pick and place machine and reflow process.
